(19) United States
(12) Patent Application Publication
(10) Pub. No.: US 2025/0088934 A1
(43) Pub. Date: Mar. 13, 2025

(54) INFORMATION PROCESSING METHOD AND APPARATUS, NETWORK-SIDE DEVICE, AND TERMINAL

(71) Applicant: VIVO MOBILE COMMUNICATION CO., LTD., Dongguan (CN)

(72) Inventors: Ranran HE, Dongguan (CN); Xiang PAN, Dongguan (CN); Xuanbing LIU, Dongguan (CN)

(73) Assignee: VIVO MOBILE COMMUNICATION CO., LTD., Dongguan (CN)

(21) Appl. No.: 18/959,576

(22) Filed: Nov. 25, 2024

Related U.S. Application Data
(63) Continuation of application No. PCT/CN2023/096163, filed on May 25, 2023.

(30) Foreign Application Priority Data
May 31, 2022 (CN) 202210612097.6

(51) Int. Cl. H04W 36/36; H04W 24/04; H04W 36/00

(52) U.S. Cl. CPC H04W 36/362; H04W 24/04; H04W 36/0069

(57) ABSTRACT

An information processing method, a network-side device, and a non-transitory computer-readable storage medium are provided. The information processing method includes receiving, by a first network node, first information reported by a terminal. The first information indicates a Secondary Cell Group (SCG) radio link failure. The SCG radio link failure includes a Conditional Primary secondary cell Addition (CPA) failure or a Conditional Primary secondary cell Change (CPC) failure. The information processing method further includes optimizing a first configuration by the first network node based on the first information. The first configuration includes any one of the following: a random access resource configuration, a CPA configuration, or a CPC configuration.

### CROSS-REFERENCE TO RELATED APPLICATIONS

This application is a continuation of International Application No. PCT/CN2023/096163, filed on May 25, 2023, which claims priority to Chinese Patent Application No. 202210612097.6, filed on May 31, 2022. The entire contents of each of the above-referenced applications are expressly incorporated herein by reference.

### TECHNICAL FIELD

This application relates to the field of communication technologies, and specifically, to an information processing method and apparatus, a network-side device, and a terminal.

### BACKGROUND

Dual Connectivity (DC) provides resources of two network nodes (access network elements) to a terminal. One of the network nodes is referred to as a Master Node (MN), and the other one is referred to as a Secondary Node (SN). The Carrier Aggregation (CA) technology is used for each network node, that is, the terminal is configured with a series of service cells controlled by the node, which are also referred to as a cell group. A cell group controlled by the MN is a Master Cell Group (MCG), and a cell group controlled by the SN is a Secondary Cell Group (SCG). Each cell group includes a Special Cell (SpCell) and a series of Secondary cells (Scells). A special cell in the MCG is referred to as a Primary Cell (PCell), and a special cell in the SCG is referred to as a Primary Secondary Cell (PSCell). In a cell group, the SpCell uses a primary carrier while the other secondary cells use a secondary carrier. Resources in a cell group are scheduled by the SpCell.

Conditional PSCell Addition or Change (CPAC) is a process of PSCell addition or change performed by the terminal when the terminal determines that all execution conditions of a target cell are met, after the network-side MN or SN sends the execution conditions of the PSCell addition or change to the terminal in advance. However, in the related art, the network-side device cannot obtain information about a CPAC failure, which causes the network side to be unable to optimize on a configuration parameter for the CPAC, resulting in communication quality degradation or service interruption.

### SUMMARY

Embodiments of this application provide an information processing method and apparatus, a network-side device, and a terminal, so that the network-side device obtains information about a Conditional PSCell Addition (CPA) failure or a Conditional PSCell Change (CPC) failure. In this case, the network-side device can optimize a configuration of the terminal, which may optimize any one of the following: a random access resource (such as a frequency domain resource or a spectrum resource) configuration, a CPA configuration, and a CPC configuration, further ensuring communication quality.

According to a first aspect, an embodiment of this application provides an information processing method, including: receiving, by a first network node, first information reported by a terminal, where the first information indicates a secondary cell group SCG radio link failure, and the SCG radio link failure includes a conditional primary secondary cell addition CPA failure or a conditional primary secondary cell change CPC failure; and optimizing a first configuration by the first network node based on the first information, where the first configuration includes any one of the following: a random access resource configuration; a CPA configuration; and a CPC configuration.

According to a second aspect, an embodiment of this application provides an information processing apparatus, including: a first receiving module, configured to receive first information reported by a terminal, where the first information indicates a secondary cell group SCG radio link failure, and the SCG radio link failure includes a conditional primary secondary cell addition CPA failure or a conditional primary secondary cell change CPC failure; and a first optimization module, configured to optimize a first configuration based on the first information, where the first configuration includes any one of the following: a random access resource configuration; a CPA configuration; and a CPC configuration.

According to a third aspect, an embodiment of this application provides an information processing method, including: receiving, by a second network node, second information sent by a first network node, where the second information includes some or all of first information, the first information indicates a secondary cell group SCG radio link failure, and the SCG radio link failure includes a conditional primary secondary cell addition CPA failure or a conditional primary secondary cell change CPC failure; and the first information is reported by a terminal to the first network node; and optimizing a random access resource configuration by the second network node based on the second information.

According to a fourth aspect, an embodiment of this application provides an information processing apparatus, including: a second receiving module, configured to receive second information sent by a first network node, where the second information includes some or all of first information, the first information indicates a secondary cell group SCG radio link failure, and the SCG radio link failure includes a conditional primary secondary cell addition CPA failure or a conditional primary secondary cell change CPC failure; and the first information is reported by a terminal to the first network node; and a second optimization module, configured to optimize a random access resource configuration based on the second information.

According to a fifth aspect, an embodiment of this application provides an information processing method, including: receiving, by a third network node, third information or fourth information sent by a first network node, where the third information or the fourth information includes some or all of first information, the first information indicates a secondary cell group SCG radio link failure, and the SCG radio link failure includes a conditional primary secondary cell addition CPA failure or a conditional primary secondary cell change CPC failure; and the first information is reported by a terminal to the first network node; and optimizing a CPA configuration by the third network node based on the third information, or optimizing a CPC configuration by the third network node based on the fourth information.

According to a sixth aspect, an embodiment of this application provides an information processing apparatus, including: a third receiving module, configured to receive third information or fourth information sent by a first network node, where the third information or the fourth information includes some or all of first information, the first information indicates a secondary cell group SCG radio link failure, and the SCG radio link failure includes a conditional primary secondary cell addition CPA failure or a conditional primary secondary cell change CPC failure; and the first information is reported by a terminal to the first network node; and a third optimization module, configured to optimize a CPA configuration based on the third information, or optimize a CPC configuration by the third network node based on the fourth information.

According to a seventh aspect, an embodiment of this application provides an information processing method, including: reporting first information by a terminal to a first network node, where the first information indicates an SCG radio link failure, and the SCG radio link failure includes a conditional primary secondary cell addition CPA failure or a conditional primary secondary cell change CPC failure.

According to an eighth aspect, an embodiment of this application provides an information processing apparatus, including a reporting unit, configured to report first information to a first network node, where the first information indicates an SCG radio link failure, and the SCG radio link failure includes a conditional primary secondary cell addition CPA failure or a conditional primary secondary cell change CPC failure.

According to a ninth aspect, an embodiment of this application provides a network- side device. The network-side device includes a processor and a memory. The memory stores a program or instructions capable of being run on the processor. The program or instructions are executed by the processor to implement steps of the method according to the first aspect or the third aspect or the fifth aspect.

According to a tenth aspect, an embodiment of this application provides a terminal. The terminal includes a processor and a memory. The memory stores a program or instructions capable of being run on the processor. The program or instructions are executed by the processor to implement steps of the method according to the seventh aspect.

According to an eleventh aspect, a communication system is provided, including a terminal and a first network node, and at least one of a second network node and a third network node. The terminal may be configured to perform steps of the method according to the seventh aspect. The first network node may be configured to perform steps of the method according to the first aspect. The second network node may be configured to perform steps of the method according to the third aspect. The third network node may be configured to perform steps of the method according to the fifth aspect.

According to a twelfth aspect, a readable storage medium is provided. The readable storage medium stores a program or instructions. The program or instructions are executed by a processor to implement steps of the method according to the first aspect, or steps of the method according to the third aspect, or steps of the method according to the fifth aspect, or steps of the method according to the seventh aspect.

According to a thirteenth aspect, a chip is provided. The chip includes a processor and a communication interface. The communication interface is coupled to the processor. The processor is configured to run a program or instructions to implement steps of the method according to the first aspect, or steps of the method according to the third aspect, or steps of the method according to the fifth aspect, or steps of the method according to the seventh aspect.

According to a fourteenth aspect, a computer program/program product is provided. The computer program/program product is stored in a storage medium. The computer program/program product is executed by at least one processor to implement steps of the method according to the first aspect, or steps of the method according to the third aspect, or steps of the method according to the fifth aspect, or steps of the method according to the seventh aspect.

In the embodiments of this application, in the case of a secondary cell group SCG radio link failure, the terminal sends first information to the first network node, where the first information indicates the SCG radio link failure, so that the network side can be informed of a conditional primary secondary cell addition CPA failure or a conditional primary secondary cell change CPC failure. In this case, the network side can optimize a CPAC parameter configuration based on the first information, thereby improving communication quality and enhancing service stability.

### BRIEF DESCRIPTION OF THE DRAWINGS

FIG. 1 is a block diagram of a wireless communication system to which the embodiments of this application are applicable;

FIG. 2 is a schematic flowchart of a CPA process according to an embodiment of this application;

FIG. 3 is a schematic flowchart of a master node-initiated inter-secondary node conditional primary secondary cell change process according to an embodiment of this application;

FIG. 4 is a schematic flowchart of a secondary node-initiated intra-secondary node conditional primary secondary cell change process according to an embodiment of this application;

FIG. 5 is a schematic flowchart of a secondary node-initiated inter-secondary node conditional primary secondary cell change process according to an embodiment of this application;

FIG. 6 is a schematic flowchart of an information processing method according to an embodiment of this application;

FIG. 7 is a schematic flowchart of an information processing method in a first case according to an embodiment of this application;

FIG. 8 is a schematic flowchart of an information processing method in a second case according to an embodiment of this application;

FIG. 9 is a schematic flowchart of an information processing method in a third case according to an embodiment of this application;

FIG. 10 is a schematic flowchart of an information processing method in a fourth case according to an embodiment of this application;

FIG. 11 is a schematic flowchart of an information processing method in a fifth case according to an embodiment of this application;

FIG. 12 is a schematic flowchart of an information processing method in a sixth case according to an embodiment of this application;

FIG. 13 is a schematic diagram of a structure of an information processing apparatus according to an embodiment of this application;

FIG. 14 is a schematic diagram of a structure of an information processing apparatus according to another embodiment of this application;

FIG. 15 is a schematic diagram of a structure of an information processing apparatus according to still another embodiment of this application;

FIG. 16 is a schematic diagram of a structure of an information processing apparatus according to yet still another embodiment of this application;

FIG. 17 is a schematic diagram of a structure of a network-side device according to an embodiment of this application; and

FIG. 18 is a schematic diagram of a structure of a terminal according to an embodiment of this application.

### DETAILED DESCRIPTION

The technical solutions in the embodiments of this application are clearly described in the following with reference to the accompanying drawings in the embodiments of this application. Apparently, the described embodiments are merely some rather than all of the embodiments of this application. All other embodiments obtained by a person of ordinary skill in the art based on the embodiments of this application shall fall within the protection scope of this application.

In the specification and claims of this application, the terms “first”, “second”, and the like are intended to distinguish between similar objects, but are not intended to describe a specific sequence or order. It should be understood that the terms used in this way are interchangeable in a proper case, so that the embodiments of this application can be implemented in an order other than the order shown or described herein. In addition, the objects distinguished by using “first” and “second” are usually of the same type, and a quantity of the objects is not limited, for example, there may be one or more first objects. In addition, “and/or” in the specification and claims indicates at least one of the connected objects, and the character “/” usually indicates an “or” relationship between the associated objects.

It is to be noted that the techniques described in the embodiments of this application are not limited to a Long Term Evolution (LTE)/LTE-Advanced (LTE-A) system, and may be further applied to other wireless communication systems, such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application are usually used interchangeably. The described technique may be applied to the systems and radio techniques mentioned above, and may also be applied to other systems and radio techniques. The following describes a New Radio (NR) system for the exemplary purpose and uses NR terminology throughout most of the following description, but these techniques may also be applied to a system other than the NR system, for example, the 6^{th} Generation (6G) communication system.

FIG. 1 is a block diagram of a wireless communication system to which the embodiments of this application are applicable. The wireless communication system includes a terminal 11 and a network-side device 12. The terminal 11 may be a mobile phone, a tablet personal computer, a laptop computer or notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or furniture), a game console, a Personal Computer (PC), a teller machine, a self-service machine, or another terminal-side device. The wearable device includes: a smartwatch, a smart band, smart headphones, smart glasses, smart jewelry (a smart bangle, a smart bracelet, a smart ring, a smart necklace, a smart anklet, and a smart ankle chain), a smart wristband, smart clothing, and the like. It needs to be noted that a specific type of the terminal 11 is not limited in the embodiments of this application. The network-side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a wireless network communication technology (Wi-Fi) node, or the like. The base station may be referred to as NodeB, evolved NodeB (eNB), an access point, a Base Transceiver Station (BTS), a radio base station, a radio transceiver, a Basic Service Set (BSS), an Extended Service Set (ESS), home NodeB, home evolved NodeB, a Transmission and Reception Point (TRP), or another proper term in the field. The base station is not limited to a specific technical term as long as the same technical effect is achieved. It needs to be noted that only a base station in the NR system is used as an example for description in the embodiments of this application, but a specific type of the base station is not limited. The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), Centralized Network Configuration (CNC), a Network Repository Function (NRF), a Network Exposure Function (NEF), a Local NEF (L-NEF), a Binding Support Function (BSF), and an Application Function (AF). It needs to be noted that only a core network device in the NR system is used as an example for description in the embodiments of this application, but a specific type of the core network device is not limited.

For ease of understanding of the embodiments of this application, the following describes terms involved in the embodiments of this application.

### (1) CPAC Includes CPA and CPC

The CPA is primary secondary cell addition performed after a terminal UE evaluates an execution condition and determines that the execution condition is met. The UE starts to evaluate the execution condition after receiving a CPA configuration. The CPA configuration includes a configuration and an execution condition of a CPA candidate cell, and the execution condition may include one or two trigger conditions.

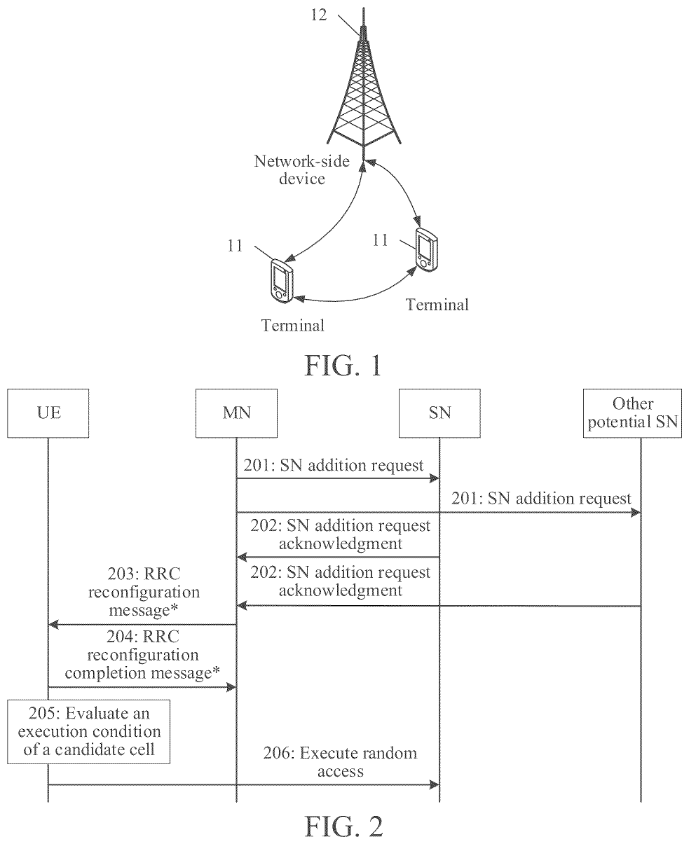

FIG. 2 is a schematic flowchart of a CPA process. As shown in FIG. 2, the CPA process includes the following steps:

Step 201: An MN decides to configure CPA for UE, and the MN sends an SN addition request to a target candidate SN and a candidate SN to request the target candidate SN and the candidate SN to allocate resources.

Step 202: In response to the MN, the target candidate SN and the candidate SN send an SN addition request acknowledgment to the MN, allocate resources for the UE, and determine PSCell and Scell.

Step 203: The MN sends a Radio Resource Control (RRC) reconfiguration message to the UE. The RRC reconfiguration message (RRC reconfiguration*) includes the following CPA configuration:

at least two candidate cells;

an RRC configuration (RRC reconfiguration**) for each candidate cell, the RRC configuration including an RRC configuration (RRCReconfiguration***) received from the candidate SN; and

an execution condition associated with each candidate cell, the execution condition including at least one trigger condition.

Step 204: The UE applies the RRC reconfiguration message (RRC reconfiguration*) of the CPA, stores the CPA configuration, and sends an RRC reconfiguration completion message (RRC reconfiguration complete*) to the MN.

Step 205: The UE starts to evaluate the execution condition.

Step 206: If all trigger conditions of a first target cell are met, the UE applies the RRC configuration (RRC reconfiguration**) of the first target cell and synchronizes with the first target cell. The first target cell is one of the candidate cells.

The CPC is primary secondary cell change performed after a terminal UE evaluates an execution condition and determines that the execution condition is met. The UE starts to evaluate the execution condition after receiving a CPC configuration. The UE stops evaluating the execution condition after the primary secondary cell change is triggered. The CPC configuration includes a configuration and an execution condition of a CPC candidate cell. The execution condition may include one or two trigger conditions. Once the primary secondary cell change process is successfully completed, the UE releases all stored CPC configurations.

The CPC includes various scenarios, such as:

Master Node-initiated inter-Secondary Node Conditional Primary secondary cell Change (MN initiated inter-SN CPC);

Secondary Node-initiated intra-Secondary Node Conditional Primary secondary cell Change (SN initiated intra-SN CPC); and

Secondary Node-initiated inter-Secondary Node Conditional Primary secondary cell Change (SN initiated inter-SN CPC).

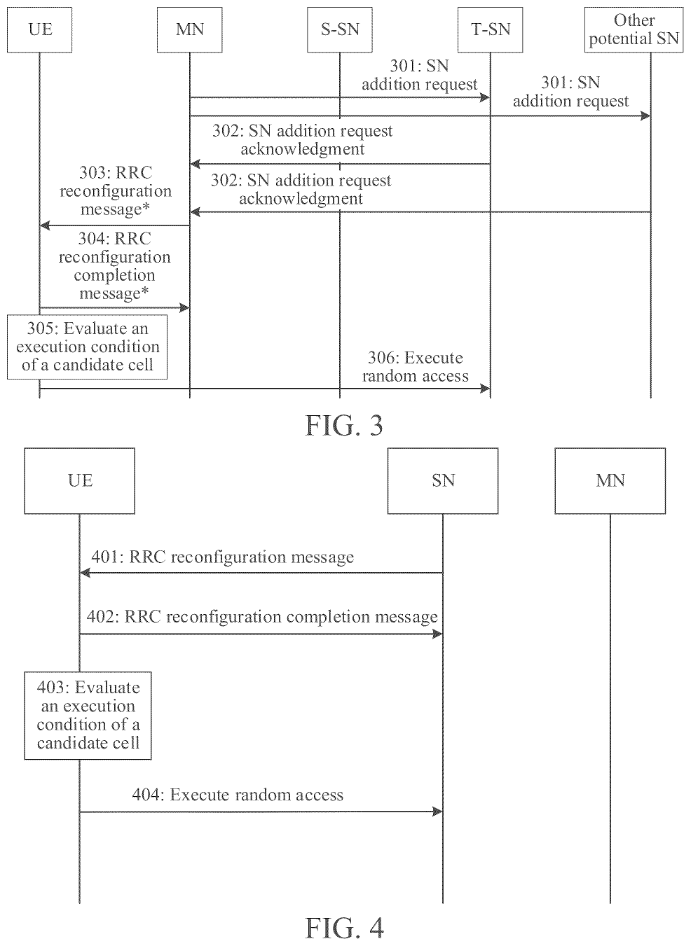

FIG. 3 is a schematic flowchart of an MN initiated inter-SN CPC process. As shown in FIG. 3, the MN initiated inter-SN CPC process includes the following steps:

Step 301: An MN decides to initiate inter-SN CPC, and sends SN Addition Request to a Target Secondary Node (Target-SN, T-SN) and a candidate SN to request the target secondary node T-SN and the candidate SN to allocate resources.

Step 302: In response to the MN (SN Addition Request Acknowledge), the T-SN and the SN determine PSCell and Scell.

Step 303: The MN determines an execution condition, and the MN sends an RRC reconfiguration message to the UE. The RRC reconfiguration message (RRC reconfiguration*) includes the following CPC configuration:

at least two candidate cells;

an RRC configuration (RRC reconfiguration**) for each candidate cell, the RRC configuration including an RRC reconfiguration (RRCReconfiguration***) received from the candidate SN; and

an execution condition associated with each candidate cell, the execution condition including at least one trigger condition.

Step 304: The UE applies the RRC reconfiguration message (RRC reconfiguration*), stores the CPC configuration, and sends an RRC reconfiguration completion message (RRC reconfiguration complete*) to the MN.

Step 305: The terminal starts to evaluate the execution condition.

Step 306: If all trigger conditions of a first target cell are met, the UE applies the RRC configuration (RRC reconfiguration**) of the first target cell, where the first target cell is one of the candidate cells; and the terminal is separated from a source secondary node S-SN and synchronizes with the first target cell.

FIG. 4 is a schematic flowchart of an SN initiated intra-SN CPC process. In this process, Signaling Radio Bearer (SRB3) needs to be pre-configured. As shown in FIG. 4, the SN initiated intra-SN CPC process includes the following steps:

Step 401: An SN decides to initiate an intra-SN CPC process (RRC reconfiguration message), and the SN determines a candidate cell and an execution condition, and sends an RRC reconfiguration message to UE through SRB3. The reconfiguration message includes a CPC configuration, including at least one of the following:

at least two candidate cells;

an RRC configuration for each candidate cell; and

an execution condition associated with each candidate cell, the execution condition including at least one trigger condition.

Step 402: The terminal applies the RRC reconfiguration message, and sends a reconfiguration completion message (RRC reconfiguration Complete message) to the SN through the SRB3.

Step 403: The terminal starts to evaluate the execution condition of the candidate cell.

Step 404: If all trigger conditions of a first target cell are met, the terminal is separated from an S-SN, applies the configuration of the first target cell, and synchronizes with the first target cell.

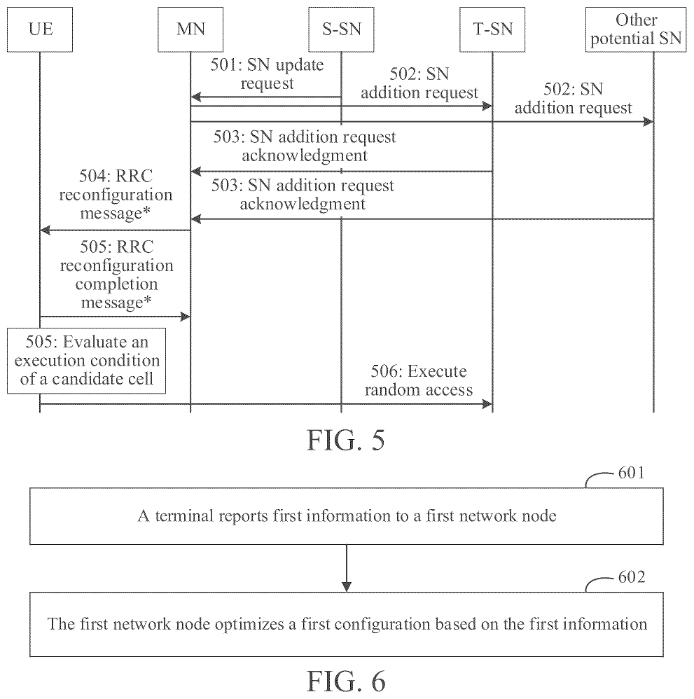

FIG. 5 is a schematic flowchart of an SN initiated inter-SN CPC process. As shown in FIG. 5, the SN initiated inter-SN CPC process includes the following steps:

Step 501: An S-SN decides to initiate an inter-SN CPC process, and sends an SN update request (Change Required) message to an MN, including a CPC initiation indication, candidate target node identification (ID) information, a cell candidate list (a list of proposed PSCell candidates), and an execution condition.

Steps 502-503: The MN negotiates with a T-SN, and the T-SN allocates resources to UE.

In step 502, the MN sends SN Addition Request to a target candidate SN and a candidate SN to request the target candidate SN and the candidate SN to allocate resources.

In step 503, in response to the MN, the target candidate SN and the candidate SN send SN Addition Request Acknowledge to the MN.

Step 504: The MN sends an RRC reconfiguration message to the UE, including a CPC reconfiguration message including at least one of the following:

at least two candidate cells;

an RRC configuration (RRC reconfiguration**) for each candidate cell, the RRC configuration including an RRC reconfiguration (RRC Reconfiguration***) received from the candidate SN; and

an execution condition associated with each candidate cell, the execution condition including at least one trigger condition.

Step 505: The UE applies the RRC reconfiguration message, stores the CPC configuration, and evaluates the execution condition of the candidate cell; and the UE sends a reconfiguration completion message (RRC reconfiguration Complete message) to the MN.

Step 506: If all trigger conditions of a first target cell are met, the UE applies the RRC configuration (RRC reconfiguration**) of the first target cell and synchronizes with the first target cell. The first target cell is one of the candidate cells.

In the related art, the network-side device cannot obtain information about a CPAC failure based on a process in the related art, which causes the network side to be unable to optimize a configuration parameter for the CPAC. The embodiments of this application provide an information processing method. By using this method, the network side can be informed of a CPA failure or a CPC failure in the case of an SCG radio link failure. In this case, the network side can optimize a CPAC parameter configuration based on the first information, such as a random access resource configuration, a CPA configuration, or a CPC configuration, thereby improving communication quality and enhancing service stability.

The following describes in detail the information processing method provided in the embodiments of this application through some embodiments and application scenarios thereof with reference to the accompanying drawings.

FIG. 6 is a schematic flowchart of an information processing method according to an embodiment of this application. As shown in FIG. 6, the information processing method includes the following steps:

Step 601: A terminal sends first information to a first network node. The first information indicates a secondary cell group SCG radio link failure, and the SCG radio link failure includes a conditional primary secondary cell addition CPA failure or a conditional primary secondary cell change CPC failure.

Step 602: The first network node optimizes a first configuration based on the first information. The first configuration includes any one of the following:

a random access resource configuration;

a CPA configuration; and

a CPC configuration.

The first information may be sent after the terminal detects that the SCG undergoes a radio link failure (for example, the SCG undergoes a primary secondary cell addition/change failure, an RRC reconfiguration failure, or T304 timeout), indicating the SCG radio link failure. The first information may include information about a CPAC failure to assist the network side in configuring a random access resource (such as a frequency domain resource or a spectrum resource) or a CPA configuration or a CPC configuration, so that the network side can optimize a CPAC parameter configuration based on the first information.

In an embodiment of this application, the CPC failure may be divided into the following cases: a secondary node-initiated intra-secondary node conditional primary secondary cell change SN initiated intra-SN CPC failure, a master node-initiated inter-secondary node conditional primary secondary cell change MN initiated inter-SN CPC failure, and a secondary node-initiated inter-secondary node conditional primary secondary cell change SN initiated inter-SN CPC failure.

In an embodiment, in a case that the terminal detects that the SCG undergoes a radio link failure and MCG transmission is not suspended, the terminal may report the first information to the first network node through SCG failure information procedure or another procedure. In other words, the first network node may receive the first information through SCG failure information procedure or another procedure. In a case that the terminal detects that the SCG undergoes a radio link failure and MCG transmission is suspended, the terminal may report the first information to the first network node through a Radio Link Failure (RLF) report procedure or an SCG failure information procedure or another procedure. In other words, the first network node may receive the first information from the terminal through RLF report procedure or SCG failure information procedure or another procedure.

In this embodiment, in a case that an SCG radio link failure occurs and MCG transmission is not suspended, the first network node is a first master node, and the first master node is a master node MN currently connected to the terminal. In a case that an SCG radio link failure occurs and MCG transmission is suspended, the first network node is a second master node or a first secondary node, the second master node is a master node T-MN after the terminal performs radio resource control RRC connection re-establishment, and the first secondary node is a secondary node that provides a radio link resource to the terminal together with the second master node, that is, the first secondary node is the secondary node T-SN that provides the radio link resource to the terminal together with the T-MN.

In an embodiment of this application, the first information includes any one of the following:

a first indication, indicating a type of the SCG radio link failure;

first time, indicating time from the most recent reception of a conditional reconfiguration including a target cell to initiation of execution of the conditional reconfiguration on the target cell, where the target cell is a target cell with a PSCell addition failure (that is, a target cell with a CPA failure) or a cell with a PSCell change failure (that is, a cell with a CPC failure);

second time, indicating time from the most recent execution of a conditional reconfiguration on the target cell to occurrence of the SCG radio link failure;

third time, indicating time from occurrence of the SCG radio link failure to re-establishment of a secondary node connection by the terminal;

fourth time, indicating time from the most recent SCG radio link failure to reporting of the first information;

at least one fifth time, indicating time from meeting an i^{th} trigger event to meeting an (i+1)^{th} trigger event in a case that the target cell is associated with a plurality of trigger events;

information about a first cell, the first cell being a cell in which the terminal initiates execution of a conditional reconfiguration;

information about at least one second cell, the second cell being a candidate cell for CPA or CPC; and

information about at least one third cell, the third cell being a non-candidate cell for CPA or CPC.

The type of the SCG radio link failure may be divided based on different granularities.

For example, in some embodiments, the type of the SCG radio link failure may be set as a CPAC failure. In some embodiments, when the terminal reports the first information due to a CPA failure, the first indication is the CPAC failure, and when the terminal reports the first information due to a CPC failure, the first indication is also the CPAC failure.

In some other embodiments, the type of the SCG radio link failure may be divided into a CPA failure or a CPC failure. For example, when the terminal reports the first information due to a CPA failure, the first indication is the CPA failure, and when the terminal reports the first information due to a CPC failure, the first indication is the CPC failure.

In some other embodiments, the type of the SCG radio link failure may be divided into a CPA failure, an SN initiated intra-SN CPC failure, an MN initiated inter-SN CPC failure, and an SN initiated inter-SN CPC failure. For example, when the terminal reports the first information due to a CPA failure, the first indication is the CPA failure; when the terminal reports the first information due to an SN initiated intra-SN CPC failure, the first indication is the SN initiated intra-SN CPC failure; when the terminal reports the first information due to an MN initiated inter-SN CPC failure, the first indication is the MN initiated inter-SN CPC failure; and when the terminal reports the first information due to an SN initiated inter-SN CPC failure, the first indication is the SN initiated inter-SN CPC failure.

In an embodiment, in CPA and CPC scenarios, the terminal may determine, based on a protocol agreement or a network-side configuration, whether to access a target cell consecutively. The consecutive access to the target cell means that when the terminal establishes a secondary node connection, if all trigger events of a first target cell are met, the terminal synchronizes with the first target cell, but if a failure occurs, while all trigger events of a second target cell are met in this process, the terminal synchronizes with the second target cell. The terminal always performs the consecutive access to the target cell if based on the protocol agreement. Based on the network-side configuration, the terminal performs the consecutive access to the target cell if the network side configures the terminal to perform the consecutive access to the target cell. For example, the network may indicate, through a 1-bit indication field, the terminal to perform or not to perform the consecutive access to the target cell. When the field exists and has a value of true, the terminal may perform the consecutive access to the target cell; and when the field does not exist or when the field exists and has a value of false, the terminal may not perform the consecutive access to the target cell, and vice versa. In some alternative embodiments, when the field has a value of 1, the terminal may perform the consecutive access to the target cell; and when the field has a value of 0, the terminal may not perform the consecutive access to the target cell, and vice versa. In this embodiment, the terminal may report the first information when accessing the second target cell, or may report the first information after accessing the second target cell. The terminal may report the first information based on the protocol agreement or the network-side configuration. For example, the protocol may agree on that the terminal performs reporting once the second target cell is accessed. In the case of consecutive access to the target cell, the third time is time from occurrence of a synchronization failure with the first target cell to successful access to the second target cell.

In an embodiment of this application, in a case that the SCG radio link failure is a CPC failure, the first information further includes information about a fourth cell, where the fourth cell is a source primary secondary cell source PSCell of the most recent CPC.

The information about the first cell, the information about the second cell, the information about the third cell, and the information about the fourth cell include at least one of the following:

information about a frequency at which a cell is located;

a physical cell ID;

a cell ID; and

cell global identity CGI information, indicating a cell global identity for logging logging, and including at least one of the following:

a globally unique identifier; and

tracking area code TAC information.

As an example, the globally unique identifier may be PLMN-Identity and Cell Identity.

In an embodiment of this application, the information about the second cell further includes at least one of the following:

at least one second indication, where each of the second indication indicates meeting or not meeting an i^{th} trigger event associated with the second cell;

at least one sixth time, where each of the sixth time indicates time from meeting an i^{th} trigger event to meeting an (i+1)^{th} trigger event associated with the second cell;

at least one third indication, where each of the third indication indicates an (N−1)^{th} met trigger event in N trigger events associated with the second cell, N being greater than or equal to 2; and a measurement result of the second cell.

The information about the third cell further includes: a measurement result of the third cell.

In an embodiment of this application, if the second cell is associated with N (N is greater than or equal to 2) trigger events, the third indication may further indicate an (N−1)^{th} met event associated with the second cell. For example, if the second cell is associated with three trigger events, the first information includes two third indications, one of the third indications indicates the first met trigger event in the trigger events associated with the second cell, and the other third indication indicates the second met trigger event.

In some embodiments of this application, in step 602, that the first network node optimizes the first configuration based on the first information may include any one of the following manners:

optimizing the first configuration directly by the first network node based on the first information;

optimizing the first configuration by the first network node through a second network node based on the first information; and

optimizing the first configuration by the first network node through a third network node based on the first information.

The optimizing the first configuration directly by the first network node based on the first information may include: analyzing the first information by the first network node, and determining a random access resource or a CPA configuration or a CPC configuration suitable for the terminal. Then, the first network node optimizes the CPA configuration or the CPC configuration directly, that is, the first network node may provide the CPA configuration or the CPC configuration to the terminal. For the random access resource, the first network node may send determined information about the random access resource to a corresponding secondary node, for the secondary node to configure a suitable random access resource for the terminal.

The optimizing the first configuration by the first network node through a second network node based on the first information means that the first network node may send some or all of the first information to the second network node, and the second network node analyzes the received information, determines a random access resource suitable for the terminal, and provides the suitable random access resource to the terminal. In other words, the first network node sends second information to the second network node; and the second network node optimizes the random access resource configuration based on the second information, where the second information includes some or all of the first information.

The second network node is a second secondary node, and a target cell in which the terminal performs CPA or CPC is deployed on the second secondary node. In a case that an SCG radio link failure occurs and MCG transmission is not suspended, if the SCG radio link failure is a CPA failure, the second secondary node is an SN on which a target cell for performing CPA is deployed; or if the SCG radio link failure is a CPC failure, the second secondary node is a T-SN on which a target cell for performing CPC is deployed. In a case that an SCG radio link failure occurs and MCG transmission is suspended, if the SCG radio link failure is a CPA failure or a CPC failure, the second secondary node is a T-SN on which a target cell for performing CPC is deployed.

In a case that the first network node sends the second information to the second network node, the first information may further include a fourth indication. The fourth indication indicates the first network node to send the second information to the second network node. The first network node may send the second information to the second network node through an SCG failure information report procedure SCG Failure Information Report procedure or another procedure.

In an embodiment of this application, the first network node may send the second information directly to the second network node, or may send the second information to the second network node via a first transit network node.

That the first network node sends the second information to the second network node via the first transit network node includes: sending fifth information by the first network node to the first transit network node, where the fifth information includes the second information; and sending the second information by the first transit network node to the second network node. The first transit network node may be one or more network nodes. For example, in a case that an SCG radio link failure occurs and MCG transmission is not suspended, the first transit network node is a secondary node S-SN before the terminal performs CPC. In a case that an SCG radio link failure occurs and MCG transmission is suspended, the first transit network node may be a master node S-MN before the terminal performs RRC connection re-establishment and/or a secondary node S-SN before the terminal performs RRC connection re-establishment. When the first transit network node includes the master node S-MN and the secondary node S-SN before the terminal performs RRC connection re-establishment, the first network node may first send information including the second information to the master node S-MN, the master node S-MN sends the information including the second information to the secondary node S-SN, and the secondary node S-SN sends the second information to the second network node; or the first network node may first send information including the second information to the secondary node S-SN, the secondary node S-SN sends the information including the second information to the master node S-MN, and the master node S-MN sends the second information to the second network node.

In an embodiment of this application, in addition to the second information, the fifth information may further include: an identifier (for example, Global NG-RAN Node ID) of the second network node and a first sending indication, the first sending indication indicating that a destination of the second information is the second network node. The first sending indication may be an explicit indication or an implicit indication. For example, the information about the second network node may implicitly indicate the first transit network node to send the fifth information to the second network node.

The behavior of sending the second information by the first network node to the second network node may be performed based on a protocol agreement or the first information. If based on the protocol agreement, once the first network node receives the first information, the first network node always needs to send the second information to the second network node. If based on the first information, whether the first network node sends the second information to the second network node may be determined through the fourth indication in the first information. The fourth indication may be an explicit indication or an implicit indication. If the fourth indication is an explicit indication, a 1-bit indication field may be used to indicate whether the first network node sends the second information to the second network node. For example, when the field exists and has a value of true, the first network node needs to send the second information to the second network node; and when the field does not exist or when the field exists and has a value of false, the first network node does not need to send the second information to the second network node, and vice versa. In some alternative embodiments, when the field has a value of 1, the first network node needs to send the second information to the second network node; and when the field has a value of 0, the first network node does not need to send the second information to the second network node, and vice versa. If the fourth indication is an implicit indication, the terminal may send some or all of the first information in the container form to the first network node, indicating that the first network node needs to send the information in the container to the second network node.

The optimizing the first configuration by the first network node through a third network node based on the first information means that the first network node may send some or all of the first information to the third network node, and the third network node analyzes the received information, determines optimization of a CPA configuration or CPC configuration, and provides an optimized CPA configuration or CPC configuration to the terminal. In other words, the first network node sends third information to the third network node, and the third network node optimizes the CPA configuration based on the third information, where the third information includes some or all of the first information; or the first network node sends fourth information to the third network node, and the third network node optimizes the CPC configuration based on the fourth information, where the fourth information includes some or all of the first information.

In a case that the SCG radio link failure is SN initiated inter-SN CPC and MCG transmission is not suspended, the third network node is a fourth secondary node, and a source cell before the terminal performs inter-SN CPC is deployed on the fourth secondary node; in a case that the SCG radio link failure is a CPA failure or an MN initiated conditional CPC failure and MCG transmission is suspended, the third network node is a third master node, and the third master node is a master node before the terminal performs radio resource control RRC connection re-establishment; or in a case that the SCG radio link failure is an SN initiated conditional intra-SN CPC failure or an SN initiated conditional inter-SN CPC failure and MCG transmission is suspended, the third network node is a secondary node before the terminal performs radio resource control RRC connection re-establishment.

In a case that the first network node sends the third information to the third network node, the first information may further include a fifth indication. The fifth indication indicates the first network node to send the third information to the third network node. In a case that the first network node sends the fourth information to the third network node, the first information may further include a sixth indication. The sixth indication indicates the first network node to send the fourth information to the third network node. The first network node sends the third information or the fourth information to the third network node through SCG Failure Information Report procedure.

In an embodiment of this application, the first network node may send the third information or the fourth information directly to the third network node, or may send the third information or the fourth information to the third network node via a second transit network node.

That the first network node sends the third information or the fourth information to the third network node via the second transit network node includes:

sending sixth information by the first network node to the second transit network node, where the sixth information includes the third information or the fourth information; and sending the third information or the fourth information by the second transit network node to the third network node.

The second transit network node may be one or more network nodes. For example, in a case that the SCG radio link failure is an SN initiated inter-SN CPC failure and MCG transmission is not suspended, the second transit network node is a fifth secondary node, and a target cell in which the terminal performs inter-SN CPC is deployed on the fifth secondary node; in a case that the SCG radio link failure is a CPA failure or an MN initiated conditional CPC failure and MCG transmission is suspended, the second transit network node is the fifth secondary node and/or a secondary node before the terminal performs CPA or CPC; or in a case that the SCG radio link failure is an SN initiated conditional intra-SN CPC failure or an SN initiated conditional inter-SN CPC failure and MCG transmission is suspended, the second transit network node is the fifth secondary node and/or a master node before the terminal performs CPC.

In an embodiment of this application, in addition to the third information or the fourth information, the sixth information may further include an identifier (for example, Global NG-RAN Node ID) of the third network node and a second sending indication, the second sending indication indicating that a destination of the third information or the fourth information is the third network node. The second sending indication may be an explicit indication or an implicit indication. For example, the information about the third network node may implicitly indicate the second transit network node to send the sixth information to the third network node.

The behavior of sending the third information or the fourth information by the first network node to the third network node may be performed based on a protocol agreement or the first information. For a process, refer to the process of the first network node sending the second information to the second network node based on the protocol agreement or the first information. Details are not described herein again in this application.

It can be learned from FIG. 2 to FIG. 5 that the SCG radio link failure includes a plurality of different types, such as a CPA failure, an SN initiated intra-SN CPC failure, an MN initiated inter-SN CPC failure, and an SN initiated inter-SN CPC failure. In the case of the SCG radio link failure, the MCG transmission may not be suspended, or the MCG transmission may be suspended. In different cases, the first network node may send the second information to the second network node or send the third information or the fourth information to the third network node. Each case is described below.

First case: A CPA failure occurs and MCG transmission is not suspended.

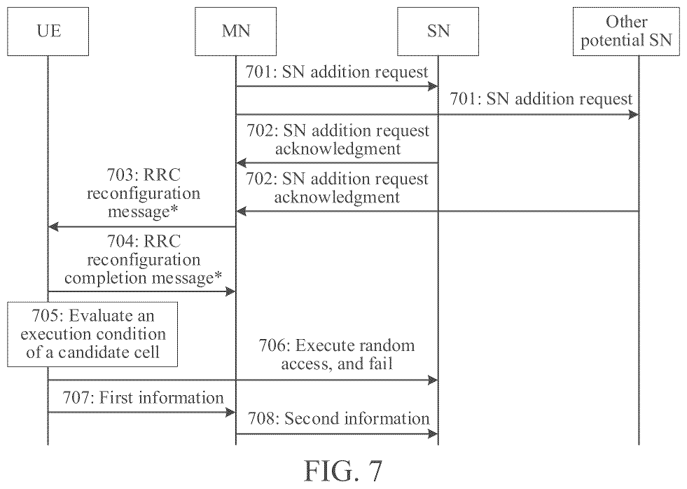

As shown in FIG. 7, in a case that the CPA failure occurs and the MCG transmission is not suspended, the first network node is a first master node, the first master node is a master node currently connected to the terminal, that is, the MN in FIG. 7, the second network node is a second secondary node, and a target cell in which the terminal performs CPA is deployed on the second secondary node, that is, the secondary node SN in the figure. Step 701 to step 706 are the same as step 201 to step 206 shown in FIG. 2. Details are not described herein again in this application. In step 706, when the terminal fails to access the target cell, the terminal detects a CPA failure.

In this embodiment, the information processing method includes the following steps:

Step 707: The MN receives first information from the terminal. In this embodiment, a first indication in the first information may be a CPAC failure or a CPA failure.

Step 708: The MN sends second information to the SN.

Second case: An MN initiated inter-SN CPC failure occurs and MCG transmission is not suspended.

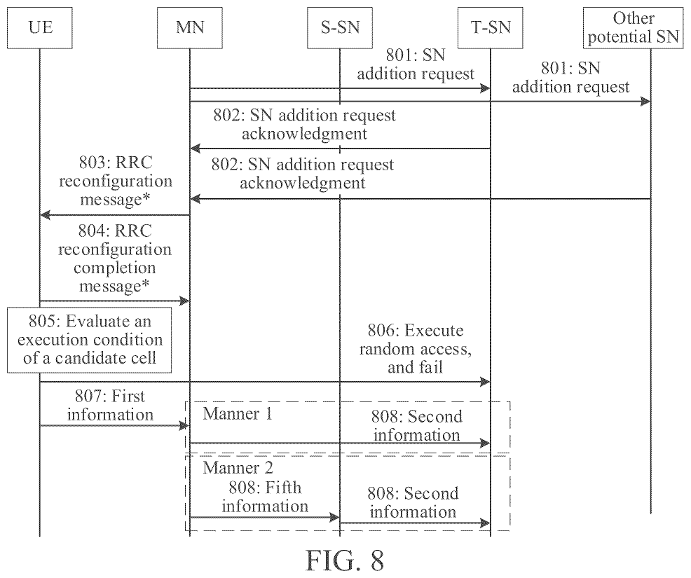

As shown in FIG. 8, in a case that the MN initiated inter-SN CPC failure occurs and the MCG transmission is not suspended, the first network node is a first master node, the first master node is a master node currently connected to the terminal, that is, the MN in FIG. 8, the second network node is a second secondary node, and a target cell in which the terminal performs inter-SN CPC is deployed on the second secondary node, that is, the target secondary node T-SN in FIG. 8. Step 801 to step 806 are the same as step 301 to step 306 shown in FIG. 3. Details are not described herein again in this application. In step 806, when the terminal fails to access the target cell, the terminal detects an MN initiated inter-SN CPC failure.

In this embodiment, the information processing method includes the following steps:

Step 807: The MN receives first information from the terminal. In this embodiment, a first indication in the first information may be a CPAC failure or a CPC failure or an SN initiated intra-SN CPC failure.

Step 808: The MN sends second information to the SN.

The MN may send the second information directly to the T-SN (for example, manner 1 in FIG. 8), or may send the second information to the T-SN via a first transit network node. The first transit network node is a secondary node before the terminal performs CPC, that is, the source secondary node S-SN in the figure.

Third case: An SN initiated intra-SN CPC failure occurs and MCG transmission is not suspended.

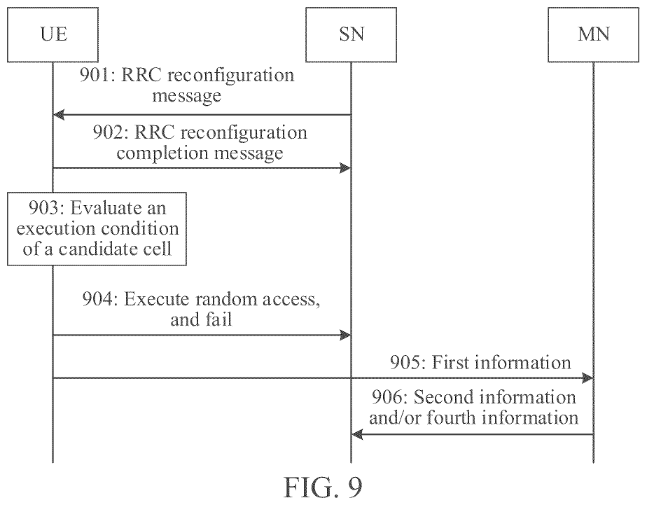

As shown in FIG. 9, in a case that the SN initiated intra-SN CPC failure occurs and the MCG transmission is not suspended, the first network node is an MN, the second network node is an SN, the third network node is a third secondary node, and a target cell in which the terminal performs intra-SN CPC is deployed on the third secondary node, that is, the SN in FIG. 9. Step 901 to step 904 are the same as step 401 to step 404 shown in FIG. 4. Details are not described herein again in this application. In step 904, if the terminal fails to access the target cell, the terminal detects an SN initiated intra-SN CPC failure.

In this embodiment, the information processing method includes the following steps:

Step 905: The MN receives first information from the terminal. In this embodiment, a first indication in the first information may be a CPAC failure or a CPC failure or an SN initiated intra-SN CPC failure.

Step 906: The MN sends second information to the SN.

Step 907: The MN sends fourth information to the SN.

Fourth case: An SN initiated inter-SN CPC failure occurs and MCG transmission is not suspended.

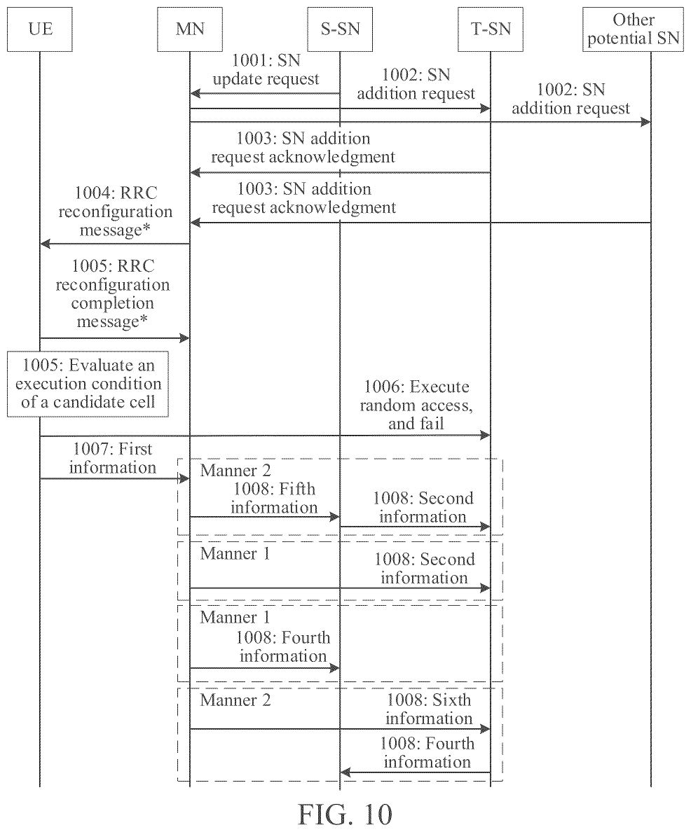

As shown in FIG. 10, in a case that the SN initiated inter-SN CPC failure occurs and the MCG transmission is not suspended, the first network node is an MN, the second network node is a T-SN, and the third network node is an S-SN. Step 1001 to step 1006 are the same as step 501 to step 506 shown in FIG. 5. Details are not described herein again in this application. In step 1006, if the terminal fails to access the target cell, the terminal detects an SN initiated intra-SN CPC failure.

In this embodiment of this application, the information processing method includes the following steps:

Step 1007: The MN receives first information from the terminal. In this embodiment, a first indication in the first information may be a CPAC failure or a CPC failure or an SN initiated inter-SN CPC failure.

Step 1008: The MN sends second information to the T-SN.

Step 1009: The MN sends fourth information to the S-SN.

The MN may send the second information directly to the T-SN (for example, manner 1 in FIG. 10), or may send the second information to the T-SN via a first transit network node (for example, manner 2 in FIG. 10). The first transit network node is a secondary node before the terminal performs CPC, that is, the S-SN in FIG. 10.

The MN may send the fourth information directly to the S-SN (for example, manner 1 in FIG. 10), or may send the fourth information to the S-SN via a second transit network node (for example, manner 2 in FIG. 10). The second transit network node is a fifth secondary node, and a target cell in which the terminal performs inter-SN CPC is deployed on the fifth secondary node, that is, the T-SN in FIG. 10.

Fifth case: The SCG radio link failure is a CPA failure or an MN initiated conditional CPC failure and the MCG transmission is suspended, and the first network node receives, through RLF report procedure, the first information reported by the terminal.

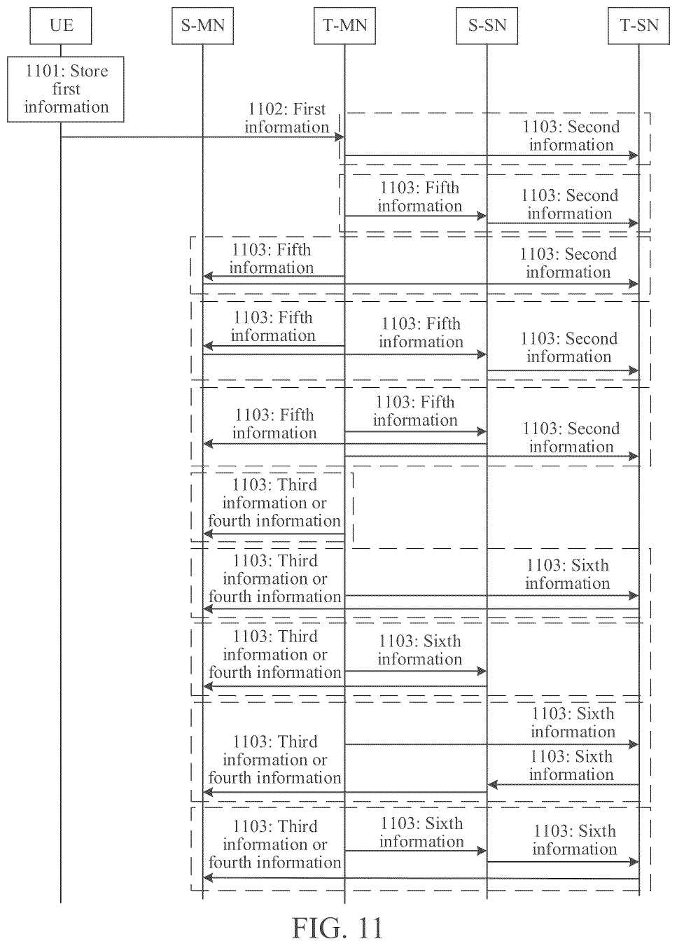

As shown in FIG. 11, in a case that the SCG radio link failure is the CPA failure and the MCG transmission is suspended, and the first network node receives, through RLF report procedure, the first information reported by the terminal, the first network node is a T-MN, the second network node is a T-SN, and the third network node is an S-MN.

In this embodiment of this application, the information processing method includes the following steps:

Step 1101: The T-MN receives the first information reported by the terminal.

Step 1102: The T-MN sends second information to the T-SN.

Step 1103: The T-MN sends third information to the S-MN.

In a case that the SCG radio link failure is the CPA failure and the MCG transmission is suspended, and the first network node receives, through RLF report procedure, the first information reported by the terminal, the first network node is a T-MN, the second network node is a T-SN, and the third network node is an S-MN.

In this embodiment of this application, the information processing method includes the following steps:

Step 1101: The T-MN receives the first information reported by the terminal.

Step 1102: The T-MN sends second information to the T-SN.

Step 1103: The T-MN sends fourth information to the S-MN.

The T-MN may send the second information directly to the T-SN, or may send the second information to the T-SN via a first transit network node. The first transit network node is a master node and/or a secondary node before the terminal performs RRC connection re-establishment, that is, the S-MN and/or the S-SN in FIG. 11. For example, that the T-MN sends the second information to the T-SN via the first transit network node includes the following manners:

Manner 2-1: The first transit network node is the S-MN.

Manner 2-2: The first transit network node is the S-SN.

Manner 2-3: The first transit network node is the S-MN and the S-SN, first to the S-MN and then to the S-SN.

Manner 2-4: The first transit network node is the S-MN and the S-SN, first to the S-SN and then to the S-MN.

The T-MN may send the third information or the fourth information directly to the S-MN, or may send the third information or the fourth information to the S-MN via a second transit network node. The second transit network node is a fifth secondary node and/or a secondary node before the terminal performs CPA or CPC, that is, the T-SN and/or the S-SN in FIG. 11. That the T-MN sends the third information or the fourth information to the S-MN via the second transit network node includes the following manners:

Manner 2-1: The second transit network node is the T-SN.

Manner 2-2: The second transit network node is the S-SN.

Manner 2-3: The second transit network node is the T-SN and the S-SN, first to the T-SN and then to the S-SN.

Manner 2-4: The second transit network node is the T-SN and the S-SN, first to the S-SN and then to the T-SN.

Sixth case: The SCG radio link failure is an SN initiated conditional intra-SN CPC failure or an SN initiated conditional inter-SN CPC failure and the MCG transmission is suspended.

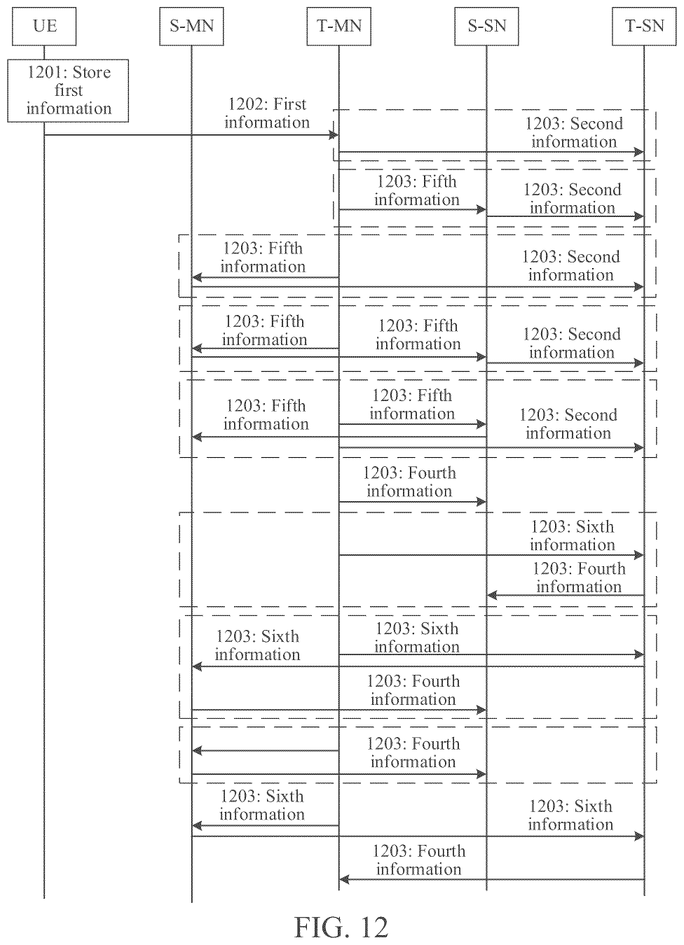

As shown in FIG. 12, in a case that the SCG radio link failure is the SN initiated conditional intra-SN CPC failure or the SN initiated conditional inter-SN CPC failure and the MCG transmission is suspended, the first network node is a T-MN, the second network node is a T-SN, and the third network node is an S-SN.

In this embodiment of this application, the information processing method includes the following steps:

Step 1201: The T-MN receives the first information reported by the terminal.

Step 1202: The T-MN sends second information to the T-SN.

Step 1203: The T-MN sends fourth information to the S-SN.

The T-MN may send the second information directly to the T-SN, or may send the second information to the T-SN via a first transit network node. The first transit network node is a master node and/or a secondary node before the terminal performs RRC connection re-establishment, that is, the S-MN and/or the S-SN in FIG. 11.

For example, that the T-MN sends the second information to the T-SN via the first transit network node includes the following manners:

Manner 2-1: The first transit network node is the S-MN.

Manner 2-2: The first transit network node is the S-SN.

Manner 2-3: The first transit network node is the S-MN and the S-SN, first to the S-MN and then to the S-SN.

Manner 2-4: The first transit network node is the S-MN and the S-SN, first to the S-SN and then to the S-MN.

The T-MN may send the fourth information directly to the S-SN, or may send the fourth information to the S-SN via a second transit network node. The second transit network node is a fifth secondary node and/or a master node before the terminal performs CPA or CPC, that is, the T-SN and/or the S-MN in FIG. 11. That the T-MN sends the fourth information to the S-SN via the second transit network node includes the following manners:

Manner 2-1: The second transit network node is the T-SN.

Manner 2-2: The second transit network node is the S-MN.

Manner 2-3: The second transit network node is the T-SN and the S-MN, first to the T-SN and then to the S-MN.

Manner 2-4: The second transit network node is the T-SN and the S-MN, first to the S-MN and then to the T-SN.

In an embodiment of this application, in a case that the terminal detects that the SCG undergoes a radio link failure and MCG transmission is suspended, the terminal may report the first information to the first network node through RLF report procedure or SCG failure information procedure or another procedure.

In a case that an SCG radio link failure occurs and MCG transmission is suspended, and the terminal reports the first information to the first network node through RLF report procedure, the information processing method in this embodiment of this application further includes:

storing the first information by the terminal (for example, in the variable VarRLF-Report of the terminal), and sending a seventh indication to the first network node during RRC connection re-establishment, where the seventh indication indicates that the first information exists in the terminal; and

reporting the first information by the terminal to the first network node through RLF report procedure in response to an eighth indication received from the first network node, where the eighth indication indicates reporting of the first information.

In a case that an SCG radio link failure occurs and MCG transmission is suspended, and the terminal reports the first information to the first network node through SCG failure information procedure, the information processing method in this embodiment of this application further includes:

storing the first information by the terminal (for example, in the variable VarSCGFailure-Report of the terminal); and

reporting the first information by the terminal to the first network node through SCG failure information procedure when RRC connection re-establishment is completed.

When reporting the first information, the terminal may further report a ninth indication and a tenth indication to the first network node through SCG failure information procedure. The ninth indication indicates that an SCG radio link failure associated with the first information is an SCG radio link failure before RRC connection re-establishment. The tenth indication indicates time from occurrence of an SCG radio link failure to reporting of the associated first information.

The foregoing process may be performed based on a protocol agreement or a network-side indication. If the foregoing process is performed based on the protocol agreement, the terminal always needs to report the first information when connection establishment is completed if the terminal stores the first information. If the foregoing process is performed based on the network-side indication, the terminal needs to report the first information when connection establishment is completed if the network configures (or enables) the terminal to store the first information, and the terminal reports the first information when connection establishment is completed if the terminal stores the first information.

In a case that an SCG radio link failure occurs and MCG transmission is suspended, and the terminal reports the first information to the first network node through SCG failure information procedure, the information processing method in this embodiment of this application further includes:

storing the first information by the terminal (for example, in the variable VarSCGFailure-Report of the terminal);

sending a seventh indication by the terminal to the first network node during RRC connection re-establishment, where the seventh indication indicates that the first information exists in the terminal; and

reporting the first information by the terminal to the first network node through SCG failure information procedure in response to an eighth indication received from the first network node, where the eighth indication indicates reporting of the first information.

There may be one or more pieces of first information reported by the terminal to the first network node. When reporting the first information, the terminal may further report a ninth indication and a tenth indication to the first network node through SCG failure information procedure, where the ninth indication indicates that an SCG radio link failure associated with the first information is an SCG radio link failure before RRC connection re-establishment or an SCG radio link failure associated with the first information is an SCG radio link failure after RRC connection re-establishment, and the tenth indication indicates time from occurrence of an SCG radio link failure to reporting of the associated first information.

In this embodiment, the information processing method further includes: releasing the first information by the terminal if the terminal does not receive the eighth indication within preset time after the terminal sends the seventh indication.

In this embodiment, the information processing method further includes: releasing the first information by the terminal after the terminal reports the first information.

In a case that an SCG radio link failure occurs and MCG transmission is suspended, and the terminal reports the first information to the first network node through SCG failure information procedure, the information processing method in this embodiment of this application further includes:

storing the first information by the terminal (for example, in the variable VarSCGFailure-Report of the terminal); and

reporting at least one first information by the terminal to the first network node through SCG failure information procedure after RRC connection re-establishment is completed in a case that an SCG radio link failure occurs on a secondary node configured for a master node currently connected to the terminal.

When reporting the first information, the terminal may further report a ninth indication and a tenth indication to the first network node through SCG failure information procedure, where the ninth indication indicates that an SCG radio link failure associated with the first information is an SCG radio link failure before RRC connection re-establishment or an SCG radio link failure associated with the first information is an SCG radio link failure after RRC connection re-establishment, and the tenth indication indicates time from occurrence of an SCG radio link failure to reporting of the associated first information.

In an embodiment of this application, the information processing method further includes: setting content of a first message by the terminal before the terminal reports the first information, where the first message carries the first information. In other words, the terminal may report the first message to the first network node to report the first information.

The setting content of a first message by the terminal includes at least one of the following:

setting, if the type of the SCG radio link failure is a CPAC failure, the first indication as the CPAC failure in a case that the terminal initiates transmission of the first message due to a CPA failure or a CPC failure;

if the type of the SCG radio link failure includes a CPA failure or a CPA failure, setting the first indication as the CPA failure in a case that the terminal initiates transmission of the first message due to the CPA failure, and setting the first indication as the CPC failure in a case that the terminal initiates transmission of the first message due to the CPC failure;

if the type of the SCG radio link failure includes a CPA failure, an SN initiated intra-SN CPC failure, an MN initiated inter-SN CPC failure, and an SN initiated inter-SN CPC failure, setting the first indication as the CPA failure in a case that the terminal initiates transmission of the first message due to the CPA failure, setting the first indication as the SN initiated intra-SN CPC failure in a case that the terminal initiates transmission of the first message due to the SN initiated intra-SN CPC failure,

setting the first indication as the MN initiated inter-SN CPC failure in a case that the terminal initiates transmission of the first message due to the MN initiated inter-SN CPC failure, and

setting the first indication as the SN initiated inter-SN CPC failure in a case that the terminal initiates transmission of the first message due to the SN initiated inter-SN CPC failure;

setting the first time as time from the most recent reception of a conditional reconfiguration including a target cell to initiation of execution of the conditional reconfiguration on the target cell;

setting the second time as time from the most recent execution of a conditional reconfiguration on the target cell to occurrence of the SCG radio link failure;

setting the third time as time from occurrence of the SCG radio link failure to re-establishment of a secondary node connection by the terminal;

setting the fourth time as time from the most recent SCG radio link failure to reporting of the first information;

setting the fifth time as time from meeting an i^{th} trigger event to meeting an (i+1)^{th} trigger event in a case that the target cell is associated with a plurality of trigger events, i being a positive integer; and

setting the information about the first cell, the information about the second cell, the information about the third cell, and the information about the fourth cell as at least one of the following:

information about a frequency at which a cell is located;

a physical cell ID;

a cell ID; and

cell global identity CGI information, indicating a cell global identity for logging logging, and including at least one of the following:

a globally unique identifier; and

tracking area code TAC information.

In an embodiment of this application, that the terminal sets the information about the second cell in the first message further includes at least one of the following:

at least one second indication, where each of the second indication indicates meeting or not meeting an i^{th} trigger event associated with the second cell;

at least one sixth time, where the sixth time indicates time from meeting an i^{th} trigger event to meeting an (i+1)^{th} trigger event associated with the second cell;

at least one third indication, where each of the third indication indicates an (N−1)^{th} met trigger event in N trigger events associated with the second cell; and a measurement result of the second cell.

In an embodiment of this application, that the terminal sets the information about the third cell in the first message further includes a measurement result of the third cell.

In the embodiments of this application, in the case of an SCG radio link failure, the terminal reports the first information to the first network node. After the first network node receives the first information reported by the terminal, the network side can be informed of, based on the first information, a conditional primary secondary cell addition CPA failure or a conditional primary secondary cell change CPC failure. In this case, the network side can optimize a CPAC parameter configuration, such as a random access resource configuration, a CPA configuration, or a CPC configuration, based on the first information, thereby improving communication quality and enhancing service stability.

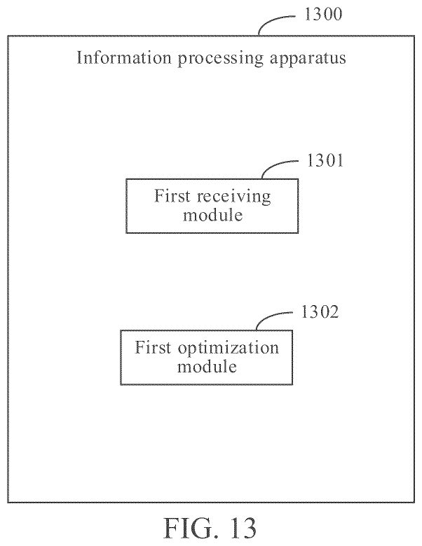

FIG. 13 is a schematic diagram of a structure of an information processing apparatus 1300 according to an embodiment of this application. The information processing apparatus 1300 may be applied to the first network node. As shown in FIG. 13, the information processing apparatus 1300 includes:

a first receiving module 1301, configured to receive first information reported by a terminal, where the first information indicates a secondary cell group SCG radio link failure, and the SCG radio link failure includes a conditional primary secondary cell addition CPA failure or a conditional primary secondary cell change CPC failure; and

a first optimization module 1302, configured to optimize a first configuration based on the first information, where

the first configuration includes any one of the following:

a random access resource configuration;

a CPA configuration; and

a CPC configuration.

The first information in this embodiment is the same as the first information in the embodiments shown in FIG. 6 to FIG. 12. To avoid repetition, details are not described herein again.

The information processing apparatus 1300 in the embodiments of this application may be an electronic device, for example, an electronic device with an operating system, or may be a component in an electronic device, for example, an integrated circuit or chip. The electronic device may be a terminal, or may be another device other than the terminal, for example, a server. This is not specifically limited in the embodiments of this application.

In an embodiment, the first optimization module 1302 is further configured to: optimize the first configuration directly based on the first information; or optimize the first configuration through a second network node based on the first information; or optimize the first configuration through a third network node based on the first information.

In an embodiment, the first optimization module 1302 is further configured to: optimize the CPA configuration or the CPC configuration directly based on the first information.

In an embodiment, the first optimization module 1302 is further configured to: send second information to the second network node, for the second network node to optimize the random access resource configuration based on the second information, where the second information includes some or all of the first information.

In an embodiment, the first optimization module 1302 is further configured to: send third information to the third network node, for the third network node to optimize the CPA configuration based on the third information, where the third information includes some or all of the first information; or send fourth information to the third network node, for the third network node to optimize the CPC configuration based on the fourth information, where the fourth information includes some or all of the first information.

In an embodiment, the first receiving module 1301 is further configured to: receive, through an SCG failure information procedure SCG failure information procedure in a case that an SCG radio link failure occurs and master cell group MCG transmission is not suspended, the first information reported by the terminal; or receive, through a radio link failure report procedure RLF report procedure or SCG failure information procedure in a case that an SCG radio link failure occurs and MCG transmission is suspended, the first information reported by the terminal; and

the first optimization module 1302 is further configured to: send the second information to the second network node through an SCG failure information report procedure SCG Failure Information Report procedure; and send the third information or the fourth information to the third network node through SCG Failure Information Report procedure.

In an embodiment, the first optimization module 1302 is further configured to: send the second information directly to the second network node; or send the second information to the second network node via a first transit network node.

In an embodiment, the first optimization module 1302 is further configured to: send fifth information to the first transit network node, where the fifth information includes the second information.

In an embodiment, the fifth information further includes: an identifier of the second network node and a first sending indication, the first sending indication indicating that a destination of the second information is the second network node.

In an embodiment, the first optimization module 1302 is further configured to: send the third information or the fourth information directly to the third network node; or send the third information or the fourth information to the third network node via a second transit network node.

In an embodiment, the first optimization module 1302 is further configured to: send sixth information to the second transit network node, where the sixth information includes the third information or the fourth information.

In an embodiment, the sixth information further includes: an identifier of the third network node and a second sending indication, the second sending indication indicating that a destination of the third information or the fourth information is the third network node.

The information processing apparatus provided in the embodiments of this application can implement the processes implemented by the first network node in the embodiments of FIG. 6 to FIG. 12, and achieve the same technical effects. To avoid repetition, details are not described herein again.

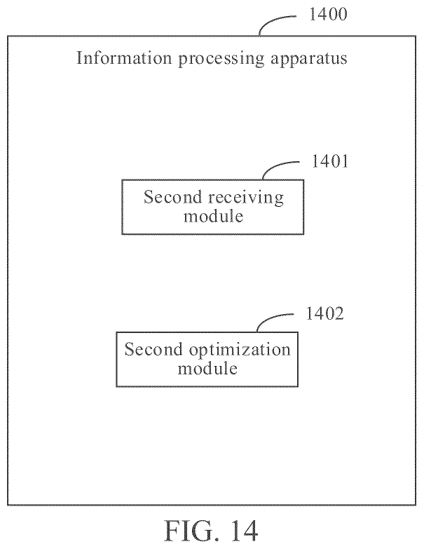

FIG. 14 is a schematic diagram of a structure of an information processing apparatus 1400 according to another embodiment of the present application. The information processing apparatus 1400 may be applied to the second network node. As shown in FIG. 14, the information processing apparatus 1400 includes:

a second receiving module 1401, configured to receive second information sent by a first network node, where the second information includes some or all of first information, the first information indicates a secondary cell group SCG radio link failure, and the SCG radio link failure includes a conditional primary secondary cell addition CPA failure or a conditional primary secondary cell change CPC failure; and the first information is reported by a terminal to the first network node; and

a second optimization module 1402, configured to optimize a random access resource configuration based on the second information.

The first information in this embodiment is the same as the first information in the embodiments shown in FIG. 6 to FIG. 12. To avoid repetition, details are not described herein again.

The information processing apparatus 1400 in the embodiments of this application may be an electronic device, for example, an electronic device with an operating system, or may be a component in an electronic device, for example, an integrated circuit or chip. The electronic device may be a terminal, or may be another device other than the terminal, for example, a server. This is not specifically limited in the embodiments of this application.

In an embodiment, the second receiving module 1401 is further configured to: receive, through SCG Failure Information Report procedure, the second information sent by the first network node.

In an embodiment, the second receiving module 1401 is further configured to: directly receive the second information sent by the first network node; or receive, via a first transit network node, the second information sent by the first network node.

In an embodiment, the second receiving module 1401 is further configured to: receive the second information sent by the first transit network node, where the first transit network node is configured to receive fifth information sent by the first network node, where the fifth information includes the second information.

In an embodiment, the fifth information further includes: an identifier of the second network node and a first sending indication, the first sending indication indicating that a destination of the second information is the second network node.

The information processing apparatus provided in the embodiments of this application can implement the processes implemented by the first network node in the embodiments of FIG. 6 to FIG. 12, and achieve the same technical effects. To avoid repetition, details are not described herein again.

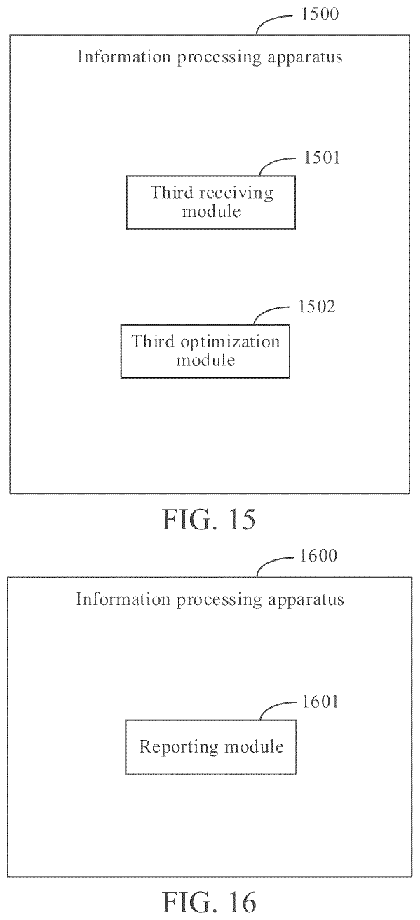

FIG. 15 is a schematic diagram of a structure of an information processing apparatus 1500 according to another embodiment of the present application. The information processing apparatus 1500 may be applied to the third network node. As shown in FIG. 15, the information processing apparatus 1500 includes:

a third receiving module 1501, configured to receive third information or fourth information sent by a first network node, where the third information or the fourth information includes some or all of first information, the first information indicates a secondary cell group SCG radio link failure, and the SCG radio link failure includes a conditional primary secondary cell addition CPA failure or a conditional primary secondary cell change CPC failure; and the first information is reported by a terminal to the first network node; and

a third optimization module 1502, configured to optimize a CPA configuration based on the third information, or optimize a CPC configuration by the third network node based on the fourth information.

The first information in this embodiment is the same as the first information in the embodiments shown in FIG. 6 to FIG. 12. To avoid repetition, details are not described herein again.

The information processing apparatus 1500 in the embodiments of this application may be an electronic device, for example, an electronic device with an operating system, or may be a component in an electronic device, for example, an integrated circuit or chip. The electronic device may be a terminal, or may be another device other than the terminal, for example, a server. This is not specifically limited in the embodiments of this application.

In an embodiment, the third receiving module 1501 is further configured to: receive, through SCG Failure Information Report procedure, the third information or the fourth information sent by the first network node.

In an embodiment, the third receiving module 1501 is further configured to: directly receive the third information or the fourth information sent by the first network node; or receive, via a second transit network node, the third information or the fourth information sent by the first network node.

In an embodiment, the third receiving module 1501 is further configured to: receive the third information or the fourth information sent by the second transit network node, where the second transit network node is configured to receive sixth information sent by the first network node, where the sixth information includes the third information or the fourth information.

In an embodiment, the sixth information further includes: an identifier of the third network node and a second sending indication, the second sending indication indicating that a destination of the third information or the fourth information is the third network node.

The information processing apparatus provided in the embodiments of this application can implement the processes implemented by the first network node in the embodiments of FIG. 6 to FIG. 12, and achieve the same technical effects. To avoid repetition, details are not described herein again.

FIG. 16 is a schematic diagram of a structure of an information processing apparatus 1600 according to another embodiment of the present application. The information processing apparatus 1600 may be applied to the terminal. As shown in FIG. 16, the information processing apparatus 1600 includes:

a reporting unit 1601, configured to report first information to a first network node, where the first information indicates an SCG radio link failure, and the SCG radio link failure includes a conditional primary secondary cell addition CPA failure or a conditional primary secondary cell change CPC failure.

In an embodiment, the reporting module 1601 is further configured to: report the first information to the first network node through SCG failure information procedure in a case that an SCG radio link failure occurs and MCG transmission is not suspended; or report the first information to the first network node through RLF report procedure or SCG failure information procedure in a case that an SCG radio link failure occurs and MCG transmission is suspended.

The first information in this embodiment is the same as the first information in the embodiments shown in FIG. 6 to FIG. 12. To avoid repetition, details are not described herein again.

The information processing apparatus 1600 in the embodiments of this application may be an electronic device, for example, an electronic device with an operating system, or may be a component in an electronic device, for example, an integrated circuit or chip. The electronic device may be a terminal, or may be another device other than the terminal, for example, a server. This is not specifically limited in the embodiments of this application.

In an embodiment, the reporting module 1601 is further configured to: store the first information, and send a seventh indication to the first network node during RRC connection re-establishment, where the seventh indication indicates that the first information exists in the terminal; and report the first information to the first network node through RLF report procedure in response to an eighth indication received from the first network node, where the eighth indication indicates reporting of the first information.

In an embodiment, the reporting module 1601 is further configured to:

store the first information;

report the first information to the first network node through SCG failure information procedure when RRC connection re-establishment is completed;

or

send a seventh indication to the first network node during RRC connection re-establishment; and

report the first information to the first network node through SCG failure information procedure in response to an eighth indication received from the first network node;

or

report the first information to the first network node through SCG failure information procedure after RRC connection re-establishment is completed if an SCG radio link failure occurs on a secondary node configured for a master node currently connected to the terminal.

In an embodiment, the reporting module 1601 is further configured to: send a ninth indication and a tenth indication to the first network node through SCG failure information procedure, where the ninth indication indicates that an SCG radio link failure associated with the first information is an SCG radio link failure before RRC connection re-establishment or an SCG radio link failure associated with the first information is an SCG radio link failure after RRC connection re-establishment, and the tenth indication indicates time from occurrence of an SCG radio link failure to reporting of the associated first information.

In an embodiment, the reporting module 1601 is further configured to: release the first information if the terminal does not receive the eighth indication within preset time after the terminal sends the seventh indication; and/or release the first information after the terminal reports the first information.

In an embodiment, the apparatus further includes a setting module, configured to set content of a first message before the first information is reported, where the first message carries the first information.

In an embodiment, the setting module is further configured to set at least one of the following:

setting, if the type of the SCG radio link failure is a CPAC failure, the first indication as the CPAC failure in a case that the terminal initiates transmission of the first message due to a CPA failure or a CPC failure;

if the type of the SCG radio link failure includes a CPA failure or a CPA failure, setting the first indication as the CPA failure in a case that the terminal initiates transmission of the first message due to the CPA failure, and setting the first indication as the CPC failure in a case that the terminal initiates transmission of the first message due to the CPC failure;

if the type of the SCG radio link failure includes a CPA failure, an SN initiated intra-SN CPC failure, an MN initiated inter-SN CPC failure, and an SN initiated inter-SN CPC failure, setting the first indication as the CPA failure in a case that the terminal initiates transmission of the first message due to the CPA failure, setting the first indication as the SN initiated intra-SN CPC failure in a case that the terminal initiates transmission of the first message due to the SN initiated intra-SN CPC failure, setting the first indication as the MN initiated inter-SN CPC failure in a case that the terminal initiates transmission of the first message due to the MN initiated inter-SN CPC failure, and setting the first indication as the SN initiated inter-SN CPC failure in a case that the terminal initiates transmission of the first message due to the SN initiated inter-SN CPC failure;

setting the first time as time from the most recent reception of a conditional reconfiguration including a target cell to initiation of execution of the conditional reconfiguration on the target cell;

setting the second time as time from the most recent execution of a conditional reconfiguration on the target cell to occurrence of the SCG radio link failure;

setting the third time as time from occurrence of the SCG radio link failure to re-establishment of a secondary node connection by the terminal;

setting the fourth time as time from the most recent SCG radio link failure to reporting of the first information;

setting the fifth time as time from meeting an i^{th} trigger event to meeting an (i+1)^{th} trigger event in a case that the target cell is associated with a plurality of trigger events, i being a positive integer; and

setting the information about the first cell, the information about the second cell, the information about the third cell, and the information about the fourth cell as at least one of the following:

information about a frequency at which a cell is located;

a physical cell ID;

a cell ID; and

cell global identity CGI information, indicating a cell global identity for logging logging, and including at least one of the following:

a globally unique identifier; and

tracking area code TAC information.

In an embodiment, the setting module is further configured to set at least one of the following:

at least one second indication, where each of the second indication indicates meeting or not meeting an i^{th} trigger event associated with the second cell;

at least one sixth time, where each of the sixth time indicates time from meeting an i^{th} trigger event to meeting an (i+1)^{th} trigger event associated with the second cell;

at least one third indication, where each of the third indication indicates an (N−1)^{th} met trigger event in N trigger events associated with the second cell; and

a measurement result of the second cell; and

the information about the third cell further includes: a measurement result of the third cell.

The information processing apparatus provided in the embodiments of this application can implement the processes implemented by the terminal in the embodiments of FIG. 6 to FIG. 12, and achieve the same technical effects. To avoid repetition, details are not described herein again.

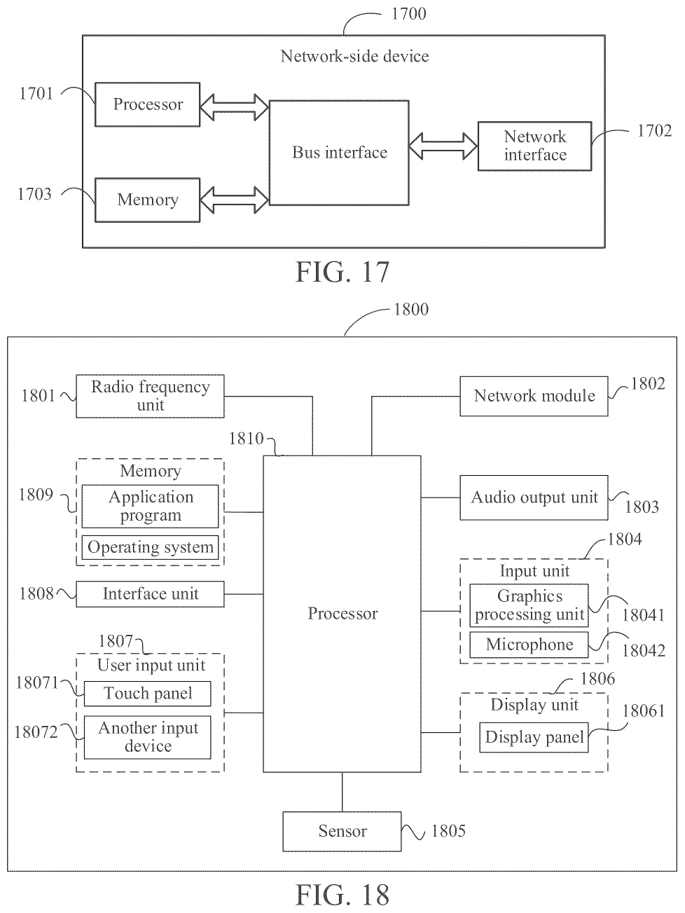

An embodiment of this application further provides a network-side device. As shown in FIG. 17, the network-side device 1700 includes: a processor 1701, a network interface 1702, and a memory 1703. The network interface 1702 is, for example, a Common Public Radio Interface (CPRI).

For example, the network-side device 1700 in this embodiment of this application further includes: a program or instructions that are capable of being run on the processor 1701 and that are stored in the memory 1703. The processor 1701 calls the program or instructions in the memory 1703 to perform the method implemented by the first network node or the second network node or the third network node in the embodiments of FIG. 6 to FIG. 12, and the same technical effects are achieved. To avoid repetition, details are not described herein again.

An embodiment of this application further provides a terminal, including a processor and a memory. The memory stores a program or instructions capable of being run on the processor. The program or instructions are executed by the processor to implement steps in the embodiments of the terminal-side method. This terminal embodiment corresponds to the foregoing method embodiment on the terminal side. The implementation processes and implementations of the method embodiment may be applied in this terminal embodiment, and the same technical effects can be achieved. For example, FIG. 18 is a schematic diagram of a hardware structure of a terminal according to an embodiment of this application.

The terminal 1800 includes, but is not limited to: at least some of components such as a radio frequency unit 1801, a network module 1802, an audio output unit 1803, an input unit 1804, a sensor 1805, a display unit 1806, a user input unit 1807, an interface unit 1808, a memory 1809, and a processor 1810.

A person skilled in the art may understand that the terminal 1800 may further include a power supply (for example, a battery) for supplying power to the components. The power supply may be logically connected to the processor 1810 through a power management apparatus, to implement functions such as charging, discharging, and power consumption management through the power management apparatus. The terminal structure shown in FIG. 18 does not constitute a limitation on the terminal, and the terminal may include more or fewer components shown in the figure, or combine some components, or have different component arrangements. Details are not described herein again.

It should be understood that, in the embodiments of this application, the input unit 1804 may include a Graphics Processing Unit (GPU) 18041 and a microphone 18042, and the graphics processing unit 18041 processes image data of static images or videos obtained by an image capture apparatus (for example, a camera) in a video capture mode or an image capture mode. The display unit 1806 may include a display panel 18061, and the display panel 18061 may be configured in the form of a liquid crystal display, an organic light-emitting diode, or the like. The user input unit 1807 includes at least one of a touch panel 18071 and another input device 18072. The touch panel 18071 is also referred to as a touchscreen. The touch panel 18071 may include two parts: a touch detection apparatus and a touch controller. The another input device 18072 may include, but is not limited to, a physical keyboard, a function key (such as a volume control key or a switch key), a track ball, a mouse, and a joystick. Details are not described herein again.

In the embodiments of this application, the radio frequency unit 1801 receives downlink data from a network-side device, and then transmits the downlink data to the processor 1810 for processing. In addition, the radio frequency unit 1801 may send uplink data to the network-side device. Usually, the radio frequency unit 1801 includes, but is not limited to, an antenna, an amplifier, a transceiver, a coupler, a low noise amplifier, a duplexer, and the like.

The memory 1809 may be configured to store a software program or instructions and various data. The memory 1809 may mainly include a first storage area storing a program or instructions and a second storage area storing data. The first storage area may store an operating apparatus, an application program or instructions required by at least one function (such as a sound playing function and an image displaying function), and the like. In addition, the memory 1809 may include a volatile memory or a non-volatile memory, or the memory 1809 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1809 in the embodiments of this application includes, but is not limited to, these memories and any other suitable types of memories.

The processor 1810 may include one or more processing units. In some embodiments, the processor 1810 may integrate an application processor and a modem processor. The application processor mainly processes an operating apparatus, a user interface, an application program, and other operations. The modem processor mainly processes a wireless communication signal, for example, a baseband processor. It may be understood that the modem processor may not be integrated into the processor 1810.

An embodiment of this application further provides a communication system, including a terminal and a first network node.

In an embodiment, the system further includes a second network node and/or a third network node.

The terminal and the first network node, and at least one of the second network node and the third network node can perform the processes in the foregoing embodiments of the information processing method, and can achieve the same technical effects. To avoid repetition, details are not described herein again.

An embodiment of this application further provides a chip. The chip includes a processor and a communication interface. The communication interface is coupled to the processor. The processor is configured to run a program or instructions to implement the processes in the embodiments of FIG. 6 to FIG. 12.

An embodiment of this application further provides a readable storage medium. The readable storage medium stores a program or instructions. The program or instructions are executed by a processor to implement the processes of the embodiments of the information processing method, and the same technical effects can be achieved. To avoid repetition, details are not described herein again.

The readable storage medium may be a non-volatile/non-transient readable storage medium, for example, may include a computer-readable storage medium, such as a computer read-only memory ROM, a random access memory RAM, a magnetic disk, or an optical disc.

An embodiment of this application provides a computer program/program product. The computer program/program product is stored in a storage medium. The computer program/program product is executed by at least one processor to implement the processes of the embodiments of the information processing method, and the same technical effects can be achieved. To avoid repetition, details are not described herein again.

The processor in the foregoing embodiments may be a processor of the terminal in the foregoing embodiments, or may be a processor of the first network node, a processor of the second network node, and/or a processor of the third network node. When the foregoing computer program/program product/readable storage medium is executed by the processor of the corresponding terminal or network node, the processes of the information processing method in the embodiments corresponding to the terminal or network node.

It needs to be noted that in this specification, the term “include”, “comprise”, or any other variant thereof is intended to cover a non-exclusive inclusion, so that a process, a method, an object, or an apparatus that includes a series of elements not only includes such elements, but also includes other elements not expressly listed, or further includes elements inherent to such process, method, object, or apparatus. If no more limitations are made, an element limited by “include a/an . . . ” does not exclude other same elements existing in the process, method, object, or apparatus that includes the element. In addition, it needs to be noted that the scope of the method and apparatus in the implementations of this application is not limited to performing functions in the shown or discussed order, and may further include performing functions in a substantially simultaneous manner or in reverse order based on the involved functions. For example, the described method may be performed in an order different from the described order, and various steps may be added, omitted, or combined. In addition, the features described in some examples may be combined in other examples.

According to the descriptions in the foregoing implementations, a person skilled in the art may clearly learn that the method according to the foregoing embodiments may be implemented by software with a general-purpose hardware platform, or by hardware. Based on such an understanding, the technical solutions of this application entirely or the part contributing to the related art may be presented in the form of a computer software product. The computer software product is stored in a storage medium (such as a ROM/RAM, a magnetic disk, or an optical disc), including several instructions to enable a terminal (which may be a mobile phone, a computer, a server, an air-conditioner, a network device, or the like) to perform the methods in the embodiments of this application.

The embodiments of this application are described above with reference to the accompanying drawings, but this application is not limited to the foregoing implementations. The foregoing implementations are merely examples rather than limitations. Under the inspiration of this application, a person of ordinary skill in the art may also make many forms without departing from the purpose of this application and the protection scope of the claims, which are all within the protection scope of this application.

What is claimed is:

1. An information processing method, comprising:
receiving, by a first network node, first information reported by a terminal, wherein the first information indicates a Secondary Cell Group (SCG) radio link failure, and the SCG radio link failure comprises a Conditional Primary secondary cell Addition (CPA) failure or a Conditional Primary secondary cell Change (CPC) failure; and
optimizing a first configuration by the first network node based on the first information, wherein the first configuration comprises any one of the following:
a random access resource configuration,
a CPA configuration, or
a CPC configuration.

2. The information processing method according to claim 1, wherein the first information comprises:
information about at least one first cell, wherein the first cell comprises a candidate cell for CPA or CPC.

3. The information processing method according to claim 2,
wherein:
the CPC failure comprises a Secondary Node-initiated intra-Secondary Node (SN initiated intra-SN) CPC failure, a Master Node-initiated inter-Secondary Node (MN initiated inter-SN) CPC failure, and a Secondary Node-initiated inter-Secondary Node (SN initiated inter-SN) CPC failure; and
a type of the SCG radio link failure is divided into any one of the following:
a Conditional Primary secondary cell Addition or Change (CPAC) failure,
a CPA failure and a CPC failure, or
a CPA failure, an SN initiated intra-SN CPC failure, an MN initiated inter-SN CPC failure, and an SN initiated inter-SN CPC failure.

4. The information processing method according to claim 3, wherein when the SCG radio link failure is a CPC failure, the first information further comprises information about a second cell, wherein the second cell is a source Primary Secondary Cell (PSCell) source of the most recent CPC.

5. The information processing method according to claim 4, wherein the information about the first cell and the information about the second cell comprise at least one of the following:
information about a frequency at which a cell is located;
a physical cell ID;
a cell ID; or
Cell Global Identity (CGI) information, indicating a cell global identity for logging, comprising at least one of the following:
a globally unique identifier; or
tracking area code TAC information.

6. The information processing method according to claim 5, wherein the information about the first cell further comprises at least one of the following:
at least one first time, wherein each of the first time indicates time from meeting an i^{th} trigger event to meeting an (i+1)^{th} trigger event associated with the first cell, i being a positive integer; or
at least one first indication, wherein each of the first indication indicates an (N−1)^{th} met trigger event in N trigger events associated with the first cell, N being greater than or equal to 2.

7. The information processing method according to claim 1, wherein optimizing the first configuration by the first network node based on the first information comprises any one of the following:
optimizing the first configuration directly by the first network node based on the first information;
optimizing the first configuration by the first network node through a second network node based on the first information; or
optimizing the first configuration by the first network node through a third network node based on the first information.

8. The information processing method according to claim 7, wherein optimizing the first configuration directly by the first network node based on the first information comprises:
optimizing the CPA configuration or the CPC configuration directly by the first network node based on the first information.

9. The information processing method according to claim 7, wherein optimizing the first configuration by the first network node through the second network node based on the first information comprises:
sending second information by the first network node to the second network node; and
optimizing the random access resource configuration by the second network node based on the second information, wherein the second information comprises some or all of the first information.

10. The information processing method according to claim 7, wherein optimizing the first configuration by the first network node through the third network node based on the first information comprises:
sending third information by the first network node to the third network node, and optimizing the CPA configuration by the third network node based on the third information, wherein the third information comprises some or all of the first information; or
sending fourth information by the first network node to the third network node, and optimizing the CPC configuration by the third network node based on the fourth information, wherein the fourth information comprises some or all of the first information.

11. The information processing method according to claim 7, wherein the first information further comprises:
a second indication, indicating the first network node to send the second information to the second network node;
or
a third indication, indicating the first network node to send the third information to the third network node;
or
a fourth indication, indicating the first network node to send the fourth information to the third network node.

12. The information processing method according to claim 7,
wherein:
receiving, by the first network node, the first information reported by the terminal comprises:
receiving, by the first network node through an SCG failure information procedure when an SCG radio link failure occurs and master cell group MCG transmission is not suspended, the first information reported by the terminal, or
receiving, by the first network node through a Radio Link Failure (RLF) report procedure or an SCG failure information procedure when an SCG radio link failure occurs and MCG transmission is suspended, the first information reported by the terminal;
sending the second information by the first network node to the second network node comprises:
sending the second information by the first network node to the second network node through an SCG failure information report procedure; and
sending the third information or the fourth information by the first network node to the third network node comprises:
sending the third information or the fourth information by the first network node to the third network node through SCG failure information report procedure.

13. The information processing method according to claim 9, wherein sending the second information by the first network node to the second network node comprises:
sending the second information directly by the first network node to the second network node;
or
sending the second information by the first network node to the second network node via a first transit network node.

14. The information processing method according to claim 13, wherein sending the second information by the first network node to the second network node via the first transit network node comprises:
sending fifth information by the first network node to the first transit network node, wherein the fifth information comprises the second information.

15. The information processing method according to claim 14, wherein the fifth information further comprises:
an identifier of the second network node and a first sending indication, the first sending indication indicating that a destination of the second information is the second network node.

16. The information processing method according to claim 10, wherein sending the third information or the fourth information by the first network node to the third network node comprises:
sending the third information or the fourth information directly by the first network node to the third network node;
or
sending the third information or the fourth information by the first network node to the third network node via a second transit network node.

17. The information processing method according to claim 16, wherein sending the third information or the fourth information by the first network node to the third network node via the second transit network node comprises:
sending sixth information by the first network node to the second transit network node, wherein the sixth information comprises the third information or the fourth information.

18. The information processing method according to claim 17, wherein the sixth information further comprises:
an identifier of the third network node and a second sending indication, the second sending indication indicating that a destination of the third information or the fourth information is the third network node.

19. A network-side device, comprising: a processor; and a memory having a computer program or an instruction stored thereon, wherein the computer program or the instruction, when executed by the processor, causes the processor to implement operations comprising:
receiving first information reported by a terminal, wherein the first information indicates a Secondary Cell Group (SCG) radio link failure, and the SCG radio link failure comprises a Conditional Primary secondary cell Addition (CPA) failure or a Conditional Primary secondary cell Change (CPC) failure; and
optimizing a first configuration based on the first information, wherein the first configuration comprises any one of the following:
a random access resource configuration,
a CPA configuration, or
a CPC configuration.

20. A non-transitory computer-readable storage medium storing instructions that, when executed by a processor, causes the processor to implement operations comprising:
receiving first information reported by a terminal, wherein the first information indicates a Secondary Cell Group (SCG) radio link failure, and the SCG radio link failure comprises a Conditional Primary secondary cell Addition (CPA) failure or a Conditional Primary secondary cell Change (CPC) failure; and
optimizing a first configuration based on the first information, wherein the first configuration comprises any one of the following:
a random access resource configuration,
a CPA configuration, or
a CPC configuration.
